(19) United States
(12) Patent Application Publication
(10) Pub. No.: US 2010/0276650 A1
(43) Pub. Date: Nov. 4, 2010

(54) Tape or rope to pull a cable into a conduit

(75) Inventor: Jerry L. Allen, Centennial, WY (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(73) Assignee: TVC Communications, L.L.C.

(21) Appl. No.: 12/660,498

(22) Filed: Mar. 1, 2010

Related U.S. Application Data
(60) Provisional application No. 61/214,806, filed on Apr. 29, 2009.

(51) Int. Cl. H02G 1/08

(52) U.S. Cl. 254/134.3 FT

(57) ABSTRACT

A device in the form of a fabric tape (13) or a rope (14) is used to pull a cable or the like into a conduit (10). A plurality of spaced plastic buttons (16) are attached to at least one side of the tape (13) or spaced plastic rings (19) are attached to the rope (14). Thus, the buttons (16) or rings (19) have a coefficient of friction less than that of the tape (13) or rope (14), respectively, and present a smaller outer surface area than the tape (17) or rope (14) so that the tape (13) or rope (14) can more easily pull the cable into the conduit (10).

### CROSS REFERENCE TO RELATED APPLICATION

This application claims priority from U.S. Provisional Patent Application Ser. No. 61/214,806 filed Apr. 29, 2009, which is incorporated herein by reference.

### TECHNICAL FIELD

This invention relates to a tape or rope used to pull a cable into a conduit or innerduct. More particularly, this invention relates to such a tape or rope which is provided with attachments that reduce surface contact between the rope or tape and the conduit or innerduct during pulling.

### BACKGROUND ART

One method of inserting a cable into a conduit, for example, a communications conduit which may extend for several miles underground, is to insert a pull tape or rope into the conduit, or into innerduct already positioned in the conduit, and then use the tape or rope to pull the cable into the conduit or innerduct. A major problem with this procedure relates to the fact that when the tape or rope is under tension pulling the cable, the tape or rope makes contact with the conduit or the innerduct along a substantial length of the conduit. The resultant friction, heat build up, and pulling tension substantially increases the difficulty of pulling the cable into the conduit thereby increasing the time that it takes to do so. Moreover, such is compounded when encountering the inevitable bends and turns in the underground conduit.

Thus, the need exists for a pull tape or rope which can be more easily be utilized to insert a cable into a conduit by reducing the pulling friction caused by the tape or rope.

### DISCLOSURE OF THE INVENTION

It is thus an object of one aspect of the present invention to provide a device which is used to more efficiently pull a cable into a conduit.

It is an object of another aspect of the present invention to provide a device, as above, which presents a smaller outer surface area to reduce the friction of the device engaging the conduit as the cable is being pulled into the conduit.

It is an object of an additional aspect of the present invention to provide a device, as above, which is in the form of a tape or a rope having members attached thereto having a lower coefficient of friction than the tape or rope.

These and other objects of the present invention, as well as the advantages thereof over existing prior art forms, which will become apparent from the description to follow, are accomplished by the improvements hereinafter described and claimed.

In general, a device made in accordance with the present invention is adapted to pull a cable or the like into a longitudinally extending conduit. The device includes a longitudinally extending material having a first coefficient of friction and a plurality of members attached to the material and being longitudinally spaced along the material. The members have a second coefficient of friction which is less than the first coefficient of friction.

In accordance with another aspect of the invention, a device which is adapted to pull a cable or the like into a longitudinally extending conduit includes a longitudinally extending material having an outer surface and a plurality of members attached to the material at longitudinally spaced positions along the outer surface. The members thus provide an outer surface area of the device which is less than the outer surface area of the material.

The forgoing aspects of the invention thus provide a device which is adapted to pull a cable or the like into a longitudinally extending conduit which includes a longitudinally extending material having a first coefficient of friction and having an outer surface. A plurality of members are attached to the material at longitudinally spaced positions along the outer surface. The members have a second coefficient of friction which is less than the first coefficient of friction and provide an outer surface area of the device which is less than the outer surface area of the material.

Preferred exemplary devices according to the concepts of the present invention are shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a fragmented perspective view of a conduit having an innerduct therein with a pull tape in each of the compartments of the innerduct.

FIG. 2 is a fragmented perspective view of a conduit having a pull rope therein.

FIG. 3 is a fragmented top plan view of a pull tape made in accordance with the present invention.

FIG. 4 is a somewhat schematic fragmented side elevational view of the pull tape of FIG. 3 shown in a conduit.

FIG. 5 is a sectional view taken substantially along line 5-5 of FIG. 3.

FIG. 6 is a fragmented top plan view of a pull rope made in accordance with the present invention.

FIG. 7 is a somewhat schematic fragmented side elevational view of the pull rope of FIG. 6 shown in a conduit.

FIG. 8 is a sectional view taken substantially along line 8-8 of FIG. 6.

### PREFERRED EMBODIMENTS FOR CARRYING OUT THE INVENTION

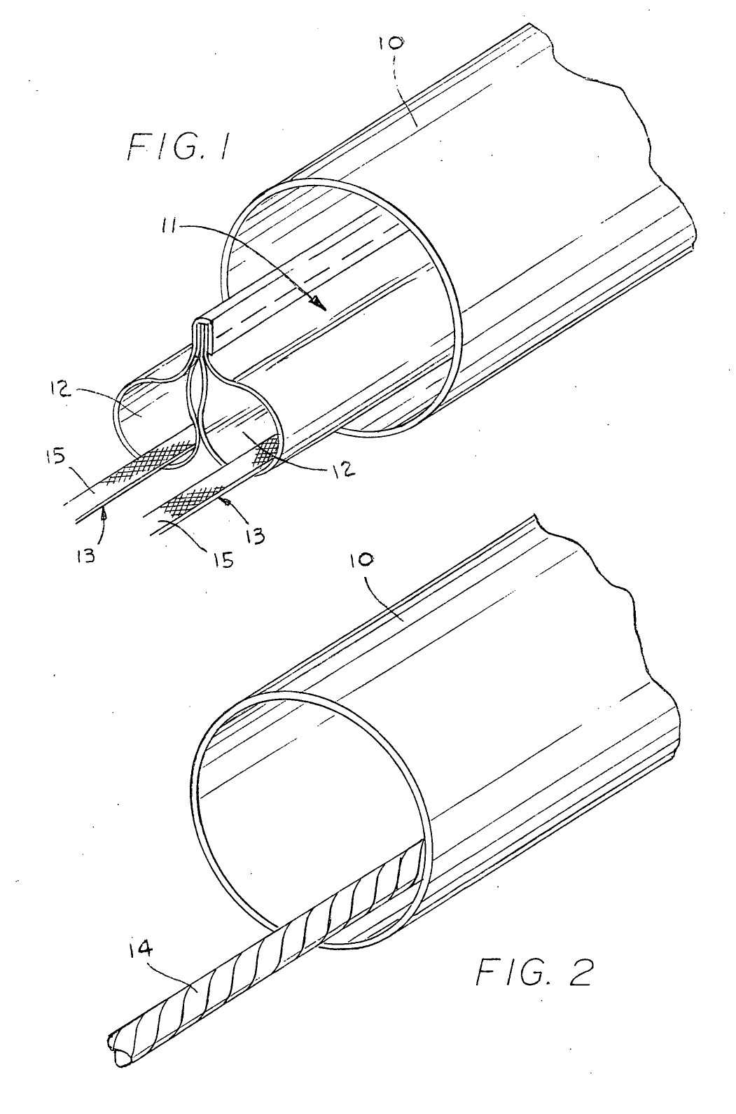

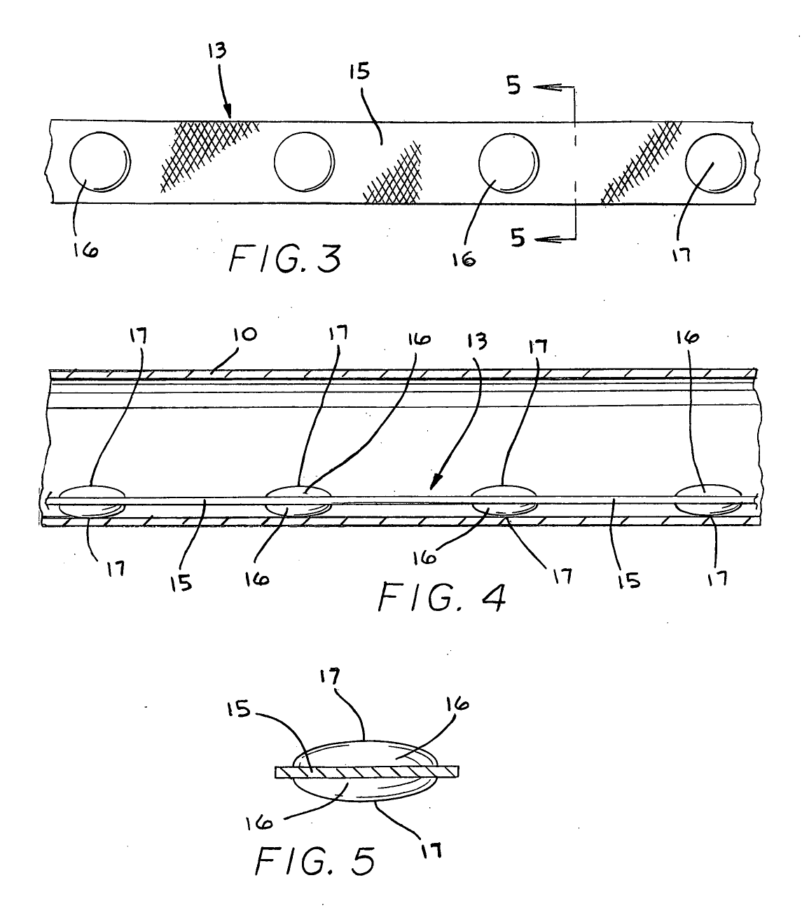

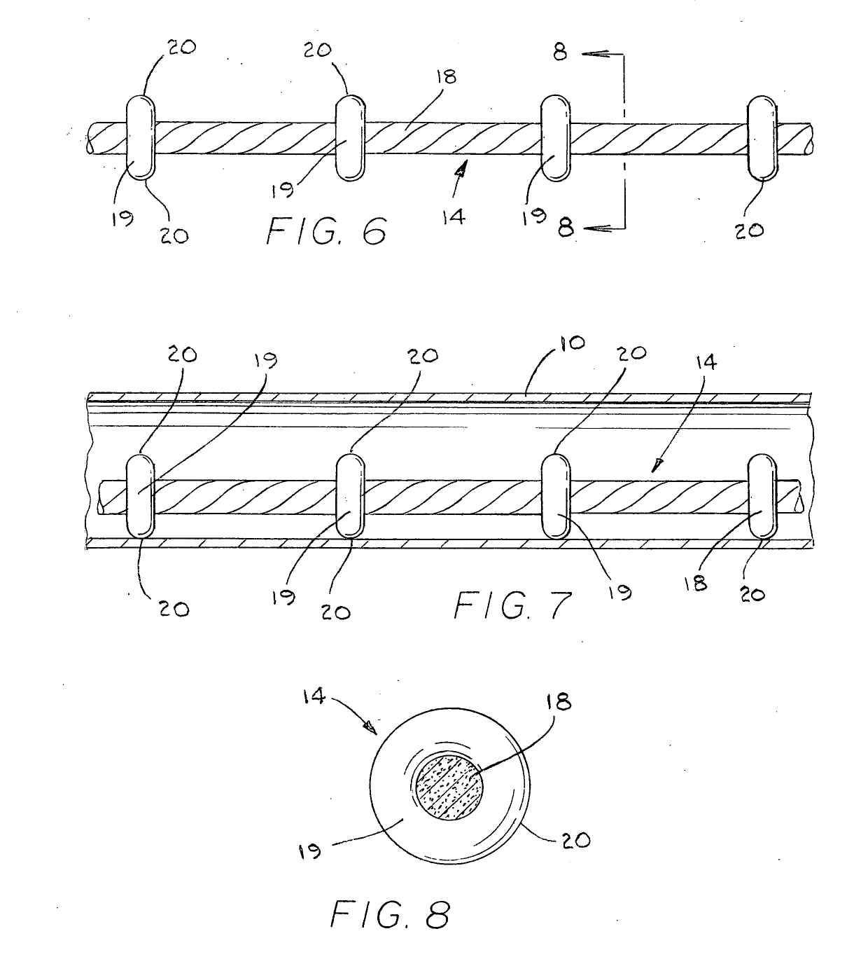

A conduit 10 is adapted to be positioned underground and to receive one or more cables therein. The conduit 10 shown in FIG. 1 is depicted as having an innerduct, generally indicated by the numeral 11, positioned therein.

lnnerduct 11 may be of a pliant fabric material such as sold under the trademark MAXCELL® by TVC Communications, L.L.C. of Annville, Pa. and described in U.S. Pat. No. 6,262,371. Innerduct 11 includes a plurality of compartments 12 (two shown in FIG. 1) each of which may ultimately receive a cable therein. To that end, a pull tape made in accordance with the present invention and generally indicated by the numeral 13 is positioned in each compartment 12. As such, a cable can be attached to one end of a tape 13, and the tape 13 is then pulled through conduit 10 thereby inserting the cable in the conduit 10.

The conduit 10 shown in FIG. 2 is depicted with a pull rope made in accordance with the present invention and generally indicated by the numeral 14. A pull rope 14 can also be used with an innerduct 11, or conversely a tape 13 can be used in a conduit 10 which does not have an innerduct, such as shown in FIG. 2. When a rope 14 is utilized, a cable can be attached to one end of rope 14, and like tape 13, rope 14 may then be pulled through conduit 10 thereby inserting a cable into a conduit 10.

Tape 13 is conventionally formed of a fabric material 15, such as nylon, polyethylene, KEVLAR®, or the like, and has an outer surface which is provided with a plurality of spaced members, shown to be in the form of buttons 16, which are attached to tape 13 by any suitable means, such as by an adhesive, threads, rivets or the like. Buttons 16 may be spaced along fabric material 15, for example, being six to twelve inches apart, and are formed with an outer arcuate surface 17 establishing high points along tape 13. Buttons 16 may be formed of any suitable hard plastic or like material which preferably has a lower coefficient of friction than that of the tape material 15 such that when being used to pull a cable through a conduit 10, as shown in FIG. 4, the arcuate surfaces 17 of tape 13 ride on the inside of conduit (or ride on the conduit through the innerduct 11). Such not only reduces the amount of contact between tape 13 and conduit 10, but also the minimal point contact of the hard plastic arcuate surfaces 17 and conduit 10 is relatively friction free. As also shown in FIG. 4, buttons 16 can be provided on the outer surfaces of both sides of the fabric material 15 and they may be aligned with each other, as shown, or they may be staggered along the length of material 15.

Rope 14 is conventionally formed of a flexible material 18, but is provided with a plurality of spaced members shown to be in the form of rings or toroidal buttons 19 which are attached to material 18 by any suitable means, such as an adhesive. Like buttons 16, rings 19 may be spaced along rope material 18, for example, being six to twelve inches apart, and can be formed with a circumferentially outer arcuate surface 20 establishing high points along the rope 14. Rings 19 may be formed of the same or similar coefficient of friction material as buttons 16 which is preferably lower than the coefficient friction of the rope material 18. When being utilized to pull a cable through conduit 10, the arcuate surface 20 of rings 19 ride on the inside surface of conduit 10 with minimal contact points. Thus, the cable can be introduced into conduit 10 with a minimal amount of friction.

It should thus be evident that devices constructed as described herein accomplish the objects of the present invention and otherwise substantially improve the art.

What is claimed is:

1. A device adapted to pull a cable or the like into a longitudinally extending conduit comprising a longitudinally extending material having a first coefficient of friction, and a plurality of members attached to said material and being longitudinally spaced along said material, said members having a second coefficient of friction which is less than said first coefficient of friction.

2. The device of claim 1 wherein said material is a fabric and said members are made of plastic.

3. The device of claim 1 wherein said members have an outer arcuate surface.

4. The device of claim 1 wherein said material is a rope and said members are made of plastic.

5. The device of claim 4 wherein said members are in the form of a ring.

6. The device of claim 1 wherein said material is in the form of a tape having opposed sides, said members being attached to one of said sides.

7. The device of claim 6 further comprising a second plurality of members attached at longitudinally spaced positions along the other of said sides.

8. A device adapted to pull a cable or the like into a longitudinally extending conduit comprising a longitudinally extending material having an outer surface, and a plurality of members attached to said material at longitudinally spaced positions along said outer surface, said members providing an outer surface area of the device which is less than said outer surface area of said material.

9. The device of claim 8 wherein said material is a fabric having a greater coefficient of friction than said members.

10. The device of claim 9 wherein said members are made of a plastic material.

11. The device of claim 10 wherein said members have an outer arcuate surface.

12. The device of claim 8 wherein said material is a rope having a greater coefficient of friction than said members.

13. The device of claim 12 wherein said members are in the form of a ring.

14. The device of claim 8, said material having a second outer surface opposed to said outer surface and further comprising a second plurality of members attached at longitudinally spaced positions along said second outer surface.

15. A device adapted to pull a cable or the like into a longitudinally extending conduit comprising a longitudinally extending material having a first coefficient of friction and having an outer surface, and a plurality of members attached to said material at longitudinally spaced positions along said outer surface, said members having a second coefficient of friction which is less than said first coefficient of friction and providing an outer surface area of the device which is less than said outer surface area of said material.

16. The device of claim 15 wherein said material is a fabric and said members are made of plastic.

17. The device of claim 15 where said members have an outer arcuate surface.

18. The device of claim 15 wherein said material is a rope and said members are made of plastic.

19. The device of claim 18 wherein said members are in the form of a ring.

20. The device of claim 15, said material having a second outer surface opposed to said outer surface and further comprising a second plurality of members attached at longitudinally spaced positions along said second outer surface.
